(19) United States
(12) Patent Application Publication
(10) Pub. No.: US 2025/0081265 A1
(43) Pub. Date: Mar. 6, 2025

(54) SYSTEM AND METHOD MEMORY OPTIMIZATION FOR MULTI-USER RLC

(71) Applicant: RAKUTEN SYMPHONY, INC., Tokyo (JP)

(72) Inventors: Vijayakumar YALAMALLI, Bangalore (IN); Haresh DAMODARAN, Bangalore (IN); Mannarapu Venkata Sandeep KUMAR, Bangalore (IN)

(21) Appl. No.: 18/247,270

(22) PCT Filed: Dec. 29, 2022
(86) PCT No.: PCT/US2022/054245

§ 371 Date: Mar. 30, 2023

(51) Int. Cl. H04W 76/15; H04W 24/02

(52) U.S. Cl. CPC H04W 76/15; H04W 24/02

(57) ABSTRACT

A method, includes sending, by processing circuitry, a packet to a user equipment (UE) to begin acknowledged mode (AM) between a distributed unit (DU) and the UE; in response to the packet being received, allocating, by the processing circuitry, a packet chunk included in a common memory pool to the UE being sent the packet from the (DU); and in response to the AM being successfully completed, returning, by the processing circuitry, the packet chunk to the common memory pool.

### TECHNICAL FIELD

This description relates to a system for memory optimization for multi-user RLC and method of using the same.

### BACKGROUND

A cellular network is a telecommunication system of mobile devices (e.g., mobile phone devices) that communicate by radio waves through one or more local antenna at a cellular base station (e.g., cell tower). Cellular service is provided to coverage areas that are divided into small geographical areas called cells. Each cell is served by a separate low-power-multichannel transceiver and antenna at a cell tower. Mobile devices within a cell communicate through that cell's antenna on multiple frequencies and on separate frequency channels assigned by the base station from a pool of frequencies used by the cellular network.

A radio access network (RAN) is part of the telecommunication system and implements radio access technology. RANs reside between a device, such as a mobile phone, a computer, or remotely controlled machine, and provide connection with a core network (CN). Depending on the standard, mobile phones and other wireless connected devices are varyingly known as user equipment (UE), terminal equipment (TE), mobile station (MS), and the like.

### SUMMARY

In some embodiments, a method, includes sending, by processing circuitry, a packet to a user equipment (UE) to begin acknowledged mode (AM) between a distributed unit (DU) and the UE; in response to the packet being received, allocating, by the processing circuitry, a packet chunk included in a common memory pool to the UE being sent the packet from the (DU); and in response to the AM being successfully completed, returning, by the processing circuitry, the packet chunk to the common memory pool.

In some embodiments, an apparatus, includes a processor; and a memory having instructions stored thereon that, in response to being executed by the processor, cause the processor to send, by processing circuitry, a packet to a user equipment (UE) to begin acknowledged mode (AM) between a distributed unit (DU) and the UE; in response to the packet being received, allocate, by the processing circuitry, a packet chunk included in a common memory pool to the UE being sent the packet from the (DU); and in response to the AM being successfully completed, return, by the processing circuitry, the packet chunk to the common memory pool.

In some embodiments, a non-transitory computer readable medium having instructions stored thereon that, in response to being executed by a processor, cause the processor to send, by processing circuitry, a packet to a user equipment (UE) to begin acknowledged mode (AM) between a distributed unit (DU) and the UE; in response to the packet being received, allocate, by the processing circuitry, a packet chunk included in a common memory pool to the UE being sent the packet from the (DU); and in response to the AM being successfully completed, return, by the processing circuitry, the packet chunk to the common memory pool.

### BRIEF DESCRIPTION OF THE DRAWINGS

Aspects of the embodiments are understood from the following detailed description when read with the accompanying Figures. In accordance with the standard practice in the industry, various features are not drawn to scale. In some embodiments, dimensions of the various features are arbitrarily increased or reduced for clarity of discussion.

FIG. 1 is a diagrammatic representation of a system for memory optimization for multi-user radio link control (RLC) (MOMR), in accordance with some embodiments.

FIG. 2 is block diagrammatic representation of a memory pool for MOMR, in accordance with some embodiments.

FIG. 3 is a flow diagram of a method for MOMR, in accordance with some embodiments.

FIG. 4 is a high-level functional block diagram of a processor-based system, in accordance with some embodiments.

### DETAILED DESCRIPTION

The following disclosure provides many different embodiments, or examples, for implementing distinctive features of the discussed subject matter. Examples of components, values, operations, materials, arrangements, or the like, are described below to simplify the embodiments. These are, of course, examples and are unintended to be limiting. Other components, values, operations, materials, arrangements, or the like, are contemplated. For example, the formation of a first feature over or on a second feature in the description that follows include embodiments in which the first and second features are formed in direct contact, and further include embodiments in which additional features are formed between the first and second features, such that the first and second features are unable to be in direct contact. In addition, some embodiments repeat reference numerals and/or letters in the numerous examples. This repetition is for the purpose of simplicity and clarity and is unintended to dictate a relationship between the various embodiments and/or configurations discussed.

Further, spatially relative terms, such as beneath, below, lower, above, upper and the like, are used herein for ease of description to describe one element or feature's relationship to another element(s) or feature(s) as illustrated in the Figures. The spatially relative terms are intended to encompass different orientations of the device in use or operation in addition to the orientation depicted in the Figures. The apparatus is otherwise oriented (rotated 90 degrees or at other orientations) and the spatially relative descriptors used herein likewise are interpreted accordingly.

In some embodiments, memory optimization for a multi-user radio link control (RLC) is discussed.

Recently, the European Telecommunications Standards Institute (ETSI) released the 5G NR (new radio) RLC protocol specification (3GPP TS 38.322 version 15.3.0 Release 15) herein incorporated by reference in entirety. In the ETSI release an 18-bit RLC sequence number was introduced which increased the RLC window length to 131,072 bits.

ETSI is an independent, not-for-profit, standardization organization in information and communications. ETSI supports the development and testing of global technical standards for information and communications technology (ICT)-enabled systems, applications, and services.

RLC is a layer 2 radio link protocol used in universal mobile telecommunications system (UMTS), long-term evolution (LTE), and 5G on the air interface. This protocol is described by 3GPP in technical standard (TS) 25.322 for UMTS, TS 36.322 for LTE and TS 38.322 for 5G New Radio (NR). RLC is located on top of the 3GPP media-access control (MAC)-layer and below the packet data convergence protocol (PDCP)-layer. The tasks of the RLC protocol are: (1) transfer of upper layer Protocol Data Units (PDUs) in one of three modes: Acknowledged Mode (AM), Unacknowledged Mode (UM) and Transparent Mode (TM), (2) error correction through ARQ (for AM data transfer), (3) concatenation, segmentation and reassembly of RLC service data units (SDUs) (UM and AM), (4) re-segmentation of RLC data PDUs (AM), (5) reordering of RLC data PDUs (UM and AM); (6) duplicate detection (UM and AM); (7) RLC SDU discard (UM and AM), (8) RLC re-establishment, and (9) protocol error detection and recovery.

In response to the increase to an 18-bit RLC sequence number, where each UE uses 131,072 bits and each gNodeB (GNB is a 3GPP-compliant implementation of the 5G-NR base station that includes independent Network Functions, which implement 3GPP-compliant NR RAN protocols) supports hundreds and thousands of users, this calls for a sizable memory allocation (number of users*131072). In a non-limiting example, for 10 UEs, a memory supports 1.31 Mbits, for 100 UEs, 13.10 Mbits, for 1,000 UEs, 131.07 Mbits, and for 10,000 UEs, 1.31 Gbits.

Though each UE calls for 131,072 bits to be stored, not all UEs call for this memory at the same time. Hence budgeting of memory for each UE is costly in the size of the memory at each GNB. In telecommunications and computer networking, a network packet is a formatted unit of data carried by a packet-switched network. A packet consists of control information and user data; the latter is also known as the payload. Control information provides data for delivering the payload (e.g., source and destination network addresses, error detection codes, or sequencing information). Typically, control information is found in packet headers and trailers. A typical packet contains 1,000 or 1,500 bytes (8,000 or 12,000 bits). Thus, 131, 072 bits correlate to approximately 11 packets.

In some embodiments, chunks of N packets/sequence are created, where N is a positive integer. In some embodiments, these chunks are common across the users. In some embodiments, memory is allocated to the users from a memory pool based on the number of packets the UE's RLC is unacknowledged for during the AM. Hence memory is unable to be reserved for each UE operably connected to a gNB, but instead memory is allocated from a common queue during the AM thus reducing the overall memory requirements. The memory footprint is reduced, thus reducing the cost.

In some embodiments, the total memory for the RLC is split into multiple chunks of N packets each. In some embodiments, the GNB UEs use the chunks of memory to perform the AM until a UE is fully acknowledged (e.g., often portions of a sequence are not received or unacknowledged and thus retransmission of the sequence is performed, and this retransmission requires more bits/bytes/packet space). In some embodiments, UEs request a chunk where there are N packets in each chunk to store AM data. In some embodiments, for the (Q+P)^{th} packet (where P is a positive integer), a new chunk is requested, and the second chunk used for the next N packets. At the same time, other UEs request other chunks with open packets (e.g., not in use to store AM data).

In some embodiments, a chunk is returned to the memory pool once acknowledgement is received for successful reception of the sequence at the UE during AM. In some embodiments, not all UEs are reserving an entire chunk, but the memory pool is able to scale up to an entire chunk for each UE actively in AM.

In some embodiments, there are N number of chunks across 3 sectors where each sector includes X number of UE's. For each UE in active AM, upon receiving the sequence packets a chunk is allocated for the UE. This chunk holds the next requested N packets for the UE. In some embodiments, the chunk is the next sequential N packets. In some embodiments, the chunk is the next non-sequential N packets. In response to receiving the (Q+P)^{th} packet (e.g., more packets are requested as the UE is having difficulty achieving the acknowledgement in AM), a new chunk is requested, and the old chunk is linked to new chunk. In response to a positive acknowledgement of reception of a packet from the UE, the packet pointers are freed from the chunk and in response, packets are freed, and the chunk is returned to memory pool.

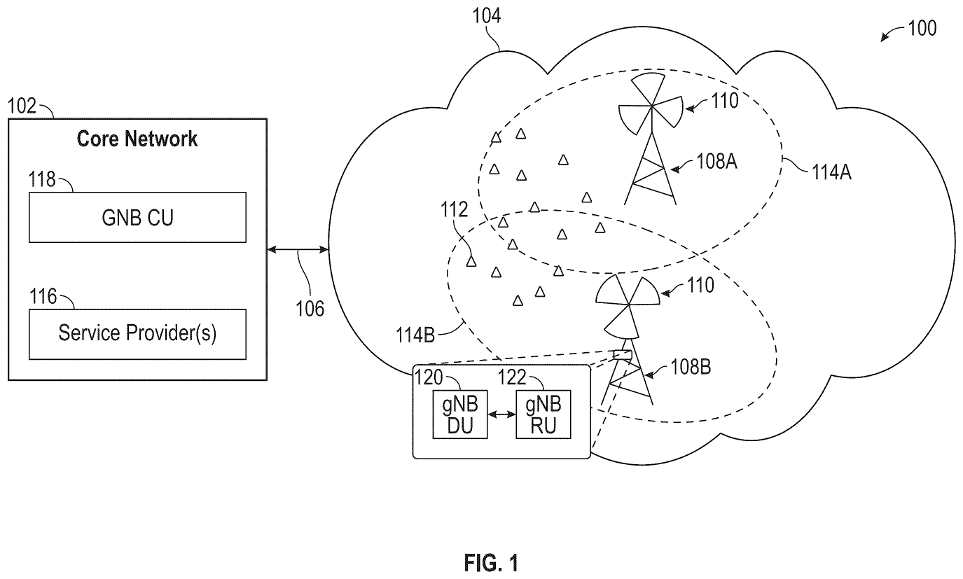

FIG. 1 is a diagrammatic representation of a system for memory optimization for multi-user RLC (MOMR) 100, in accordance with some embodiments.

MOMR system 100 includes a CN 102 communicatively connected to RAN 104 through transport network 106, which is communicatively connected to base stations 108A and 108B (hereinafter base station 108), with antennas 110 that are wirelessly connected to UEs 112 located in geographic coverage cells 114A and 114B (hereinafter geographic coverage cells 114). CN 102 includes one or more service provider(s) 116.

CN 102 (further known as a backbone) is a part of a computer network which interconnects networks, providing a path for the exchange of information between different local area networks (LANs) or subnetworks. In some embodiments, CN 102 ties together diverse networks over wide geographic areas, in different buildings in a campus environment, or in the same building.

In some embodiments, RAN 104 is a global system for mobile communications (GSM) RAN, a GSM/EDGE RAN, a UMTS RAN (UTRAN), an evolved UMTS terrestrial radio access network (E-UTRAN), open RAN (O-RAN), or cloud-RAN (C-RAN). RAN 104 resides between UE 112 (e.g., mobile phone, a computer, or any remotely controlled machine) and CN 102. In some embodiments, RAN 104 is a C-RAN for purposes of simplified representation and discussion. In some embodiments, base band units (BBU) replace the C-RAN.

In a hierarchical telecommunications network, transport network 106 of MOMR system 100 includes the intermediate link(s) between CN 102 and RAN 104. The two main methods of mobile backhaul implementations are fiber-based backhaul and wireless point-to-point backhaul. Other methods, such as copper-based wireline, satellite communications and point-to-multipoint wireless technologies are being phased out as capacity and latency requirements become higher in 4G and 5G networks. Backhaul refers to the side of the network that communicates with the Internet. The connection between base station 108 and UE 112 begins with transport network 106 connected to CN 102. In some embodiments, transport network 106 includes wired, fiber optic, and wireless components. Wireless sections include using microwave bands, mesh, and edge network topologies that use high-capacity wireless channels to get packets to the microwave or fiber links.

In some embodiments, base stations 108 are gNB base stations that connect 5G New Radio (NR) devices (e.g., 5G phones) to the 5G core network using the NR radio interface. In some embodiments, base stations 108 are lattice or self-supported towers, guyed towers, monopole towers, and concealed towers (e.g., towers designed to resemble trees, cacti, water towers, signs, light standards, and other types of structures). In some embodiments, base stations 108 are a cellular-enabled mobile device site where antennas and electronic communications equipment are placed, typically on a radio mast, tower, or other raised structure to create a cell (or adjacent cells) in a network. The raised structure typically supports antenna(s) 110 and one or more sets of transmitter/receivers (transceivers), digital signal processors, control electronics, a remote radio head (RRH), primary and backup electrical power sources, and sheltering. Base stations are known by other names such as base transceiver station, mobile phone mast, or cell tower. In some embodiments, other edge devices are configured to wirelessly communicate with UEs. The edge device provides an entry point into service provider CNs, such as CN 102. Examples include routers, routing switches, integrated access devices (IADs), multiplexers, and a variety of metropolitan area network (MAN) and wide area network (WAN) access devices.

In at least one embodiment, antenna(s) 110 are a sector antenna. In some embodiments, antenna(s) 110 are a type of directional microwave antenna with a sector-shaped radiation pattern. In some embodiments, the sector degrees of arc are 60°, 90°, or 120° designs with a few degrees extra to ensure overlap. Further, sector antennas are mounted in multiples when wider coverage or a full-circle coverage is desired. In some embodiments, antenna(s) 110 are a rectangular antenna, sometimes called a panel antenna or radio antenna, used to transmit and receive waves or data between mobile devices or other devices and a base station. In some embodiments, antenna(s) 110 are circular antennas. In some embodiments, antenna 110 operates at microwave or ultra-high frequency (UHF) frequencies (300 MHz to 3 GHz). In other examples, antenna(s) 110 are chosen for their size and directional properties. In some embodiments, the antenna(s) 110 are MIMO (multiple-input, multiple-output) antennas that send and receive greater than one data signal simultaneously over the same radio channel by exploiting multipath propagation.

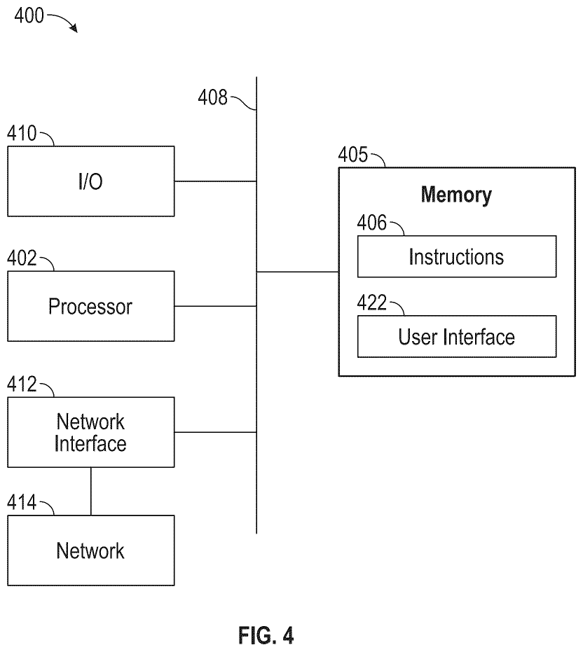

In some embodiments, UEs 112 are a computer or computing system. Additionally, or alternatively, UEs 112 have a liquid crystal display (LCD), light-emitting diode (LED) or organic light-emitting diode (OLED) screen interface, such as user interface (UI) 422 (FIG. 4), providing a touchscreen interface with digital buttons and keyboard or physical buttons along with a physical keyboard. In some embodiments, UE 112 connects to the Internet and interconnects with other devices. Additionally, or alternatively, UE 112 incorporates integrated cameras, the ability to place and receive voice and video telephone calls, video games, and Global Positioning System (GPS) capabilities. Additionally, or alternatively, UEs run operating systems (OS) that allow third-party apps specialized for capabilities to be installed and run. In some embodiments, UEs 112 are a computer (such as a tablet computer, netbook, digital media player, digital assistant, graphing calculator, handheld game console, handheld personal computer (PC), laptop, mobile Internet device (MID), personal digital assistant (PDA), pocket calculator, portable medial player, or ultra-mobile PC), a mobile phone (such as a camera phone, feature phone, smartphone, or phablet), a digital camera (such as a digital camcorder, or digital still camera (DSC), digital video camera (DVC), or front-facing camera), a pager, a personal navigation device (PND), a wearable computer (such as a calculator watch, smartwatch, head-mounted display, earphones, or biometric device), or a smart card.

In some embodiments, geographic coverage cells 114 include a shape and size. In some embodiments, geographic coverage cells 114 are a macro-cell (covering 1 Km-30 Km), a micro-cell (covering 200 m-2 Km), or a pico-cell (covering 4 m-200 m). In some embodiments, geographic coverage cells are circular, oval (FIG. 1), sector, or lobed in shape, but geographic coverage cells 114 are configured in most any shape or size. Geographic coverage cells 114 represent the geographic area antenna 110 and UEs 112 are configured to communicate.

Service provider(s) 116 or CSPs are businesses, vendors, customers, or organizations that sell bandwidth or network access to subscribers (utilizing UEs) by providing direct Internet backbone access to Internet service providers and usually access to network access points (NAPs). Service providers are sometimes referred to as backbone providers, Internet providers, or vendors. Service providers include telecommunications companies, data carriers, wireless communications providers, Internet service providers, and cable television operators offering high-speed Internet access.

In a 5G RAN architecture, the BBU functionality is split into two functional units: a distributed unit (DU) 120, responsible for real time L1 and L2 scheduling functions, and a centralized unit (CU) 118 responsible for non-real time, higher L2 and L3. In a 5G cloud RAN, such as RAN 104, the DU's server and relevant software are hosted on a site, such as base station 108, or are hosted in an edge cloud (e.g., datacenter or central office) depending on transport availability and fronthaul interface. The split between DU 120 and RU 122 are different depending on the specific use-case and implementation.

CU 118 includes RRC (Radio Resource Control protocol is a layer 3 (Network Layer) protocol used between UE, such as UEs 112, and base station, such as base stations 108), SDAP (service data adaption protocol that maps the quality of service (QOS)), and PDCP protocol layers, and is responsible for non-real-time RRC, PDCP protocol stack functions. CU 118 is deployed in the cloud to support the integrated deployment of core network UPF (User Plane Function is the function that does the work to connect the data over the RAN to the Internet) sinking and edge computing. CU 118 and DU 120 are connected through the F1 interface. One CU manages one or more DUs.

The DU software is deployed on-site, such as base stations 108, on a COTS (commercial off-the-shelf) server. DU software is normally deployed close to RU 122 on-site and runs the RLC (radio link control), MAC, and parts of the PHY layer (the layer most closely associated with the physical connection between devices).

RU 122 is the radio hardware unit that coverts radio signals sent to and from antenna 110 into a digital signal for transmission over packet networks. RU 122 handles the digital front end (DFE) and the lower PHY layer, as well as the digital beamforming functionality. RUs are deployed on-site.

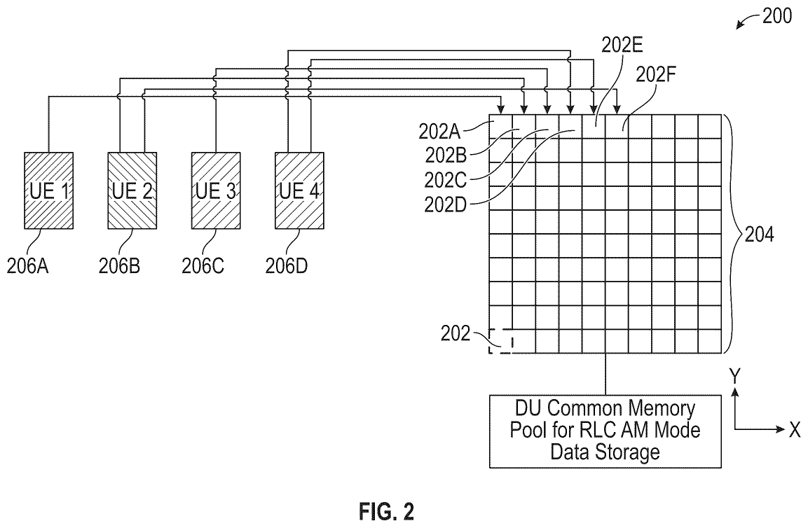

FIG. 2 is block diagrammatic representation of a memory pool for MOMR 200, in accordance with some embodiments.

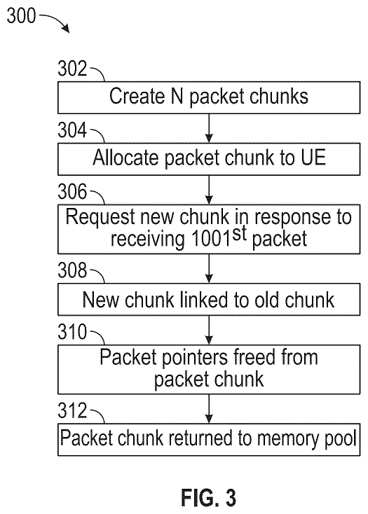

FIG. 3 is a flow diagram of a method for MOMR 300, in accordance with some embodiments.

FIGS. 2 and 3 are discussed together to provide an understanding of the operation of MOMR system 100 and memory pool for MOMR 200 through method for MOMR 300. In some embodiments, method for MOMR 300 is a functional overview MOMR system 100 and memory pool for MOMR 200. Method for MOMR 300 is executed by processing circuitry 402 discussed below with respect to FIG. 4. In some embodiments, some, or all the operations of method for MOMR 300 are executed in accordance with instructions corresponding to instructions 406 discussed below with respect to FIG. 4.

Method for MOMR 300 includes operations 302-312, but the operations are not necessarily performed in the order shown. Operations are added, replaced, order changed, and/or eliminated as appropriate, in accordance with the spirit and scope of the embodiments. In some embodiments, one or more of the operations of method for MOMR 300 are repeated. In some embodiments, unless specifically stated otherwise, the operations of method for MOMR 300 are performed in order.

In some embodiments, memory pool for MOMR 200 is included with a DU, such as DU 120. In some embodiments, memory pool for MOMR 200 is a DU common memory pool for a RLC acknowledged mode (AM) data storage.

In 5G NR, RLC has 3 different modes of operations transparent mode (TM), unacknowledged mode (UM) and AM and each of the modes transmit and receive data, serving different logical channels. In some embodiments, characteristics of RLC AM include: (1) buffering performed at transmission and reception, (2) segmentation performed at transmission and reassembly at reception, (3) feedback mechanism for acknowledgment (ACK)/(NACK) not acknowledged for RLC PDU, (4) data for (signalling radio bearer) SRB1/SRB2/SRB3 and data radio bearers (DRBs), (5) sequence number (SN) size (12,18) bits, (6) RLC AM mode complete/segmented SDU is associated with SN, (7) 1 RLC SDU=1 RLC PDU.

In AM, each RLC PDU is sent a packet in ascending order and stored in memory pool 200. As RLC AM supports ARQ (initiated in response to the RLC entity transmitting side beginning a polling procedure that triggers STATUS reporting from the AM RLC entity receiving side) to ensure reliable delivery, therefore the RLC STATUS PDU message is sent by a UE to indicate the status of RLC PDUs received at the UE.

At operation 302 of method for MOMR 300, N (where N is a positive integer) number of packet chunks 202 are created across M (where M is a positive integer) sectors, such as sector 204, where each sector is configured to support X (where X is a positive integer) number of UEs per sector. In some embodiments, M is three. In some embodiments, packet chunks, such as packet chunk 202, includes N packets. In some embodiments, packet chunks are created by processing circuitry 402 of FIG. 4. In some embodiments, memory pool 200 includes M sectors, such as sector 204, and is the total memory for a RLC is split into multiple packet chunks. In some embodiments, each of packet chunks 202 are common to all UEs (e.g., UEs 206A, 206B, 206C, and 206D). In some embodiments, common describes packet chunks that are accessible to any UE, unless the packet chunk, such as packet chunks 202A, 202B, 202C, 202D, 202E, and 202F. Process flows from operation 302 to operation 304.

At operation 304 of method for MOMR 300, a packet chunk, like packet chunk 202, is allocated to a UE, such as UE 206A, 206B, 206C, or 206D, from a sector, such as sector 204, included in memory pool 200 based on an unacknowledged number of packets for the UEs RLC. In some embodiments, memory is not reserved for each UE, but instead is allocated from common memory pool 200, thus reducing overall memory requirements. The memory footprint is reduced. A memory allotment is not required for each UE, thus reducing the cost of additional memory. In some embodiments, common memory pool 200 and the packet chunks 202 are common to all UEs and once the AM is complete, packet chunks 202 allocated to a UE are opened back up for use by another UE. In some embodiments, gNB users use the packet chunks of memory. In some embodiments, UEs request the packet chunk to store up to N packets in each packet chunk. Process flows from operation 304 to operation 306.

At operation 306 of method for MOMR 300, in response to receiving the (Q+P)^{th} packet, a new packet chuck is requested. In some embodiments, for the (Q+P)^{th} packet, a new packet chunk is requested, and the new packet chunk is used for the next N packets. In FIG. 2, in a non-limiting example, UE1 206A is allotted packet chunk 202A, UE2 206B is allotted packet chunk 202B, UE3 206C is allotted packet chunk 202C, and UE 206D is allotted packet chunk 202D. Continuing with the non-limiting example, in response to UE2 206B receiving the (Q+P)^{th} packet, new packet chunk 202E is requested and allotted. Continuing with the non-limiting example, in response to UE4 206D receiving the (Q+P)^{th} packet, new packet chunk 202F is requested and allotted. Process flows from operation 306 to operation 308.

At operation 308 of method for MOMR 300, in response to a new packet chunk being allotted, the old packet chunk is linked to the new chunk. Continuing with the non-limiting example above, packet chunk 202B is linked to packet chunk 202E (each with common UE 206B) and packet chunk 202D is linked to packet chunk 202F (each with common UE 206D). Process flows from operation 308 to operation 310.

At operation 310 of method for MOMR 300, in response to a positive acknowledgement (ACK) of reception of the packet from the UE, packet pointers are freed from the packet chunk. In computer science, a pointer is an object in many programming languages that stores a memory address. This is another value located in computer memory, or in some cases, that of memory-mapped computer hardware. A pointer references a location in memory, and obtaining the value stored at that location is known as dereferencing the pointer. As an analogy, a page number in a book's index could be considered a pointer to the corresponding page; dereferencing such a pointer would be done by flipping to the page with the given page number and reading the text found on that page.

In some embodiments, other UEs are still using packets remaining within the chunk. In some embodiments, UEs reserve the full memory included in a packet chunk even through the full memory is not necessary. In some embodiments, each packet chunk scales up to use the full memory of each packet chunk for the UE. Process flows from operation 310 to operation 312.

At operation 312 of method for MOMR 300, in response to all packets being freed, the packet chunk is returned to the memory pool. In some embodiments, a packet chunk, such as packet 202, is returned to common memory pool 200 once acknowledgement (ACK) is received indicating successful reception of the packet at the UE. In some embodiments, each UE within a cell, such as cells 114A and 114B, is not in need of a packet chunk (e.g., not operating in AM), but instead request a packet chunk during AM.

FIG. 4 is a block diagram of processing circuitry 400 to optimize memory for multi-user RLC in accordance with some embodiments. In some embodiments, processing circuitry 400 to optimize memory for multi-user RLC is a general-purpose computing device including a hardware processor 402 and a non-transitory, computer-readable storage medium 404. Storage medium 404, amongst other things, is encoded with, i.e., stores, computer program code 406, i.e., a set of executable instructions such as an algorithm, or method 300. Execution of instructions 406 by hardware processor 402 represents (at least in part) a method to optimize memory for multi-user RLC which implements a portion, or all the methods described herein in accordance with one or more embodiments (hereinafter, the noted processes and/or methods).

Processor 402 is electrically coupled to a computer-readable storage medium 404 via a bus 408. Processor 402 is further electrically coupled to an I/O interface 410 by bus 408. A network interface 412 is further electrically connected to processor 402 via bus 408. Network interface 412 is connected to a network 414, so that processor 402 and computer-readable storage medium 404 connect to external elements via network 414. Processor 402 is configured to execute computer program code 406 encoded in computer-readable storage medium 404 to cause processing circuitry 400 to optimize memory for multi-user RLC to be usable for performing a portion or all the noted processes and/or methods. In one or more embodiments, processor 402 is a central processing unit (CPU), a multi-processor, a distributed processing system, an application specific integrated circuit (ASIC), and/or a suitable processing unit.

In one or more embodiments, computer-readable storage medium 404 is an electronic, magnetic, optical, electromagnetic, infrared, and/or a semiconductor system (or apparatus or device). For example, computer-readable storage medium 404 includes a semiconductor or solid-state memory, a magnetic tape, a removable computer diskette, a random-access memory (RAM), a read-only memory (ROM), a rigid magnetic disk, and/or an optical disk. In one or more embodiments using optical disks, computer-readable storage medium 404 includes a compact disk-read only memory (CD-ROM), a compact disk-read/write (CD-R/W), and/or a digital video disc (DVD).

In one or more embodiments, storage medium 404 stores computer program code 406 configured to cause processing circuitry 400 to optimize memory for multi-user RLC to be usable for performing a portion or all the noted processes and/or methods. In one or more embodiments, storage medium 404 further stores information, such as an algorithm which facilitates performing a portion or all the noted processes and/or methods.

Processing circuitry 400 to optimize memory for multi-user RLC includes I/O interface 410. I/O interface 410 is coupled to external circuitry. In one or more embodiments, I/O interface 410 includes a keyboard, keypad, mouse, trackball, trackpad, touchscreen, and/or cursor direction keys for communicating information and commands to processor 402.

Processing circuitry 400 to create non-expiring URLs further includes network interface 412 coupled to processor 402. Network interface 412 allows processing circuitry 400 to create non-expiring URLs to communicate with network 414, to which one or more other computer systems are connected. Network interface 412 includes wireless network interfaces such as BLUETOOTH, WIFI, WIMAX, GPRS, or WCDMA; or wired network interfaces such as ETHERNET, USB, or IEEE-864. In one or more embodiments, a portion or all noted processes and/or methods, is implemented in two or more processing circuitry 400 to create non-expiring URLs.

Processing circuitry 400 to create non-expiring URLs is configured to receive information through I/O interface 410. The information received through I/O interface 410 includes one or more of instructions, data, design rules, and/or other parameters for processing by processor 402. The information is transferred to processor 402 via bus 408. processing circuitry 400 to optimize memory for multi-user RLC is configured to receive information related to UI 422 through I/O interface 410. The information is stored in computer-readable medium 404 as user interface (UI) 422.

In some embodiments, a portion or all the noted processes and/or methods is implemented as a standalone software application for execution by a processor. In some embodiments, a portion or all the noted processes and/or methods is implemented as a software application that is a part of an additional software application. In some embodiments, a portion or all the noted processes and/or methods is implemented as a plug-in to a software application.

In some embodiments, a method, includes sending, by processing circuitry, a packet to a user equipment (UE) to begin acknowledged mode (AM) between a distributed unit (DU) and the UE; in response to the packet being received, allocating, by the processing circuitry, a packet chunk included in a common memory pool to the UE being sent the packet from the (DU); and in response to the AM being successfully completed, returning, by the processing circuitry, the packet chunk to the common memory pool.

In some embodiments, the method further includes before the sending the packet to the UE to begin the AM between the DU and the UE creating, by the processing circuitry, N number of packet chunks, where N is a positive integer, included in the common memory pool.

In some embodiments, the method further includes creating, by the processing circuitry, M sectors, where M is a positive integer, of packet chunks where the N number of packet chunks are distributed over the M sectors.

In some embodiments, the method further incudes distributing, by the processing circuitry, X number of UEs, where X is a positive integer, per sector.

In some embodiments, the method further includes requesting, by the processing circuitry, an additional packet chunk for the UE, based on a next requested packet being sent the UE, which exceeds a packet size of the packet chunk.

In some embodiments, the packet size of the packet chunk and the additional packet chunk is Q packets, where Q is a positive integer; and the next requested packet is a (Q+P)^{th} packet received, where P is a positive integer.

In some embodiments, the method further includes linking, by the processing circuitry, the additional packet chunk to the packet chunk.

In some embodiments, the method further includes before the returning the packet chunk to the common memory pool, removing packet pointers from the packet chunk.

In some embodiments, an apparatus, includes a processor; and a memory having instructions stored thereon that, in response to being executed by the processor, cause the processor to send, by processing circuitry, a packet to a user equipment (UE) to begin acknowledged mode (AM) between a distributed unit (DU) and the UE; in response to the packet being received, allocate by the processing circuitry, a packet chunk included in a common memory pool to the UE being sent the packet from the (DU); and in response to the AM being successfully completed, return, by the processing circuitry, the packet chunk to the common memory pool.

In some embodiments, the instructions, in response to being executed by the processor, further cause the processor to before the sending the SN to the UE to begin the AM between the DU and the UE create, by the processing circuitry, N number of packet chunks, where N is a positive integer, included in the common memory pool.

In some embodiments, the instructions, in response to being executed by the processor, further cause the processor to create, by the processing circuitry, M sectors, where M is a positive integer, of packet chunks where the N number of packet chunks are distributed over the M sectors.

In some embodiments, the instructions, in response to being executed by the processor, further cause the processor to distribute, by the processing circuitry, X number of UEs, where X is a positive integer, per sector.

In some embodiments, the instructions, in response to being executed by the processor, further cause the processor to request, by the processing circuitry, an additional packet chunk for the UE, based on a next requested packet being sent to the UE, which exceeds a packet size of the packet chunk.

In some embodiments, the packet size of the packet chunk and the additional packet chunk is Q packets, where Q is a positive integer; and the next requested packet is a (Q+P)^{th} packet received, where P is a positive integer.

In some embodiments, the instructions, in response to being executed by the processor, further cause the processor to link, by the processing circuitry, the additional packet chunk to the packet chunk.

In some embodiments, the instructions, in response to being executed by the processor, further cause the processor to before the returning the packet chunk to the common memory pool, remove packet pointers from the packet chunk.

In some embodiments, a non-transitory computer readable medium having instructions stored thereon that, in response to being executed by a processor, cause the processor to send, by processing circuitry, a packet to a user equipment (UE) to begin acknowledged mode (AM) between a distributed unit (DU) and the UE; in response to the packet being received, allocate by the processing circuitry, a packet chunk included in a common memory pool to the UE being sent the packet from the (DU); and in response to the AM being successfully completed, return, by the processing circuitry, the packet chunk to the common memory pool.

In some embodiments, the instructions, in response to being executed by the processor, further cause the processor to before the sending the packet to the UE to begin the AM between the DU and the UE create, by the processing circuitry, N number of packet chunks, where N is a positive integer, included in the common memory pool.

In some embodiments, the instructions, in response to being executed by the processor, further cause the processor to create, by the processing circuitry, M sectors, where M is a positive integer, of packet chunks where the N number of packet chunks are distributed over the M sectors.

In some embodiments, the instructions, in response to being executed by the processor, further cause the processor to distribute, by the processing circuitry, X number of UEs, where X is a positive integer, per sector.

The foregoing outlines features of several embodiments so that those skilled in the art better understand the aspects of the embodiments. Those skilled in the art should appreciate that they readily use the embodiments as a basis for designing or modifying other processes and structures for conducting the same purposes and/or achieving the same advantages of the embodiments introduced herein. Those skilled in the art should further realize that such equivalent constructions do not depart from the spirit and scope of the embodiments, and that they make various changes, substitutions, and alterations herein without departing from the spirit and scope of the embodiments.

What is claimed is:

1. A method, comprising:
sending, by processing circuitry, a packet to a user equipment (UE) to begin acknowledged mode (AM) between a distributed unit (DU) and the UE;
in response to the packet being received, allocating, by the processing circuitry, a packet chunk included in a common memory pool to the UE being sent the packet from the (DU); and
in response to the AM being successfully completed, returning, by the processing circuitry, the packet chunk to the common memory pool.

2. The method of claim 1, further comprising:
before the sending the packet to the UE to begin the AM between the DU and the UE creating, by the processing circuitry, N number of packet chunks, where N is a positive integer, included in the common memory pool.

3. The method of claim 2, further comprising:
creating, by the processing circuitry, M sectors, where M is a positive integer, of packet chunks where the N number of packet chunks are distributed over the M sectors.

4. The method of claim 3, further comprising:
distributing, by the processing circuitry, X number of UEs, where X is a positive integer, per sector.

5. The method of claim 1, further comprising:
requesting, by the processing circuitry, an additional packet chunk for the UE, based on a next requested packet being sent to the UE, which exceeds a packet size of the packet chunk.

6. The method of claim 5, wherein:
the packet size of the packet chunk and the additional packet chunk is Q packets, where Q is a positive integer; and
the next requested packet is an (Q+P)^{th} packet received, where P is a positive integer.

7. The method of claim 5, further comprising:
linking, by the processing circuitry, the additional packet chunk to the packet chunk.

8. The method of claim 1, further comprising:
before the returning the packet chunk to the common memory pool, removing packet pointers from the packet chunk.

9. An apparatus, comprising:
a processor; and
a memory having instructions stored thereon that, in response to being executed by the processor, cause the processor to:
send, by processing circuitry, a packet to a user equipment (UE) to begin acknowledged mode (AM) between a distributed unit (DU) and the UE;
in response to the packet being received, allocate, by the processing circuitry, a packet chunk included in a common memory pool to the UE being sent the packet from the (DU); and
in response to the AM being successfully completed, return, by the processing circuitry, the packet chunk to the common memory pool.

10. The apparatus of claim 9, wherein the instructions, in response to being executed by the processor, further cause the processor to:
before the sending the packet to the UE to begin the AM between the DU and the UE create, by the processing circuitry, N number of packet chunks, where N is a positive integer, included in the common memory pool.

11. The apparatus of claim 10, wherein the instructions, in response to being executed by the processor, further cause the processor to:
create, by the processing circuitry, M sectors, where M is a positive integer, of packet chunks where the N number of packet chunks are distributed over the M sectors.

12. The apparatus of claim 11, wherein the instructions, in response to being executed by the processor, further cause the processor to:
distribute, by the processing circuitry, X number of UEs, where X is a positive integer, per sector.

13. The apparatus of claim 9, wherein the instructions, in response to being executed by the processor, further cause the processor to:
request, by the processing circuitry, an additional packet chunk for the UE, based on a next requested packet being sent to the UE, which exceeds a packet size of the packet chunk.

14. The apparatus of claim 13, wherein:
the packet size of the packet chunk and the additional packet chunk is Q packets, where Q is a positive integer; and
the next requested packet is a (Q+P)^{th} packet received, where P is a positive integer.

15. The apparatus of claim 13, wherein the instructions, in response to being executed by the processor, further cause the processor to:
link, by the processing circuitry, the additional packet chunk to the packet chunk.

16. The apparatus of claim 1, wherein the instructions, in response to being executed by the processor, further cause the processor to:
before the returning the packet chunk to the common memory pool, remove packet pointers from the packet chunk.

17. A non-transitory computer readable medium having instructions stored thereon that, in response to being executed by a processor, cause the processor to:
send, by processing circuitry, a packet to a user equipment (UE) to begin acknowledged mode (AM) between a distributed unit (DU) and the UE;
in response to the packet being received, allocate by the processing circuitry, a packet chunk included in a common memory pool to the UE being sent the packet from the (DU); and
in response to the AM being successfully completed, return, by the processing circuitry, the packet chunk to the common memory pool.

18. The non-transitory computer readable medium of claim 17, wherein the instructions, in response to being executed by the processor, further cause the processor to:
before the sending the packet to the UE to begin the AM between the DU and the UE create, by the processing circuitry, N number of packet chunks, where N is a positive integer, included in the common memory pool.

19. The non-transitory computer readable medium of claim 18, wherein the instructions, in response to being executed by the processor, further cause the processor to:
create, by the processing circuitry, M sectors, where M is a positive integer, of packet chunks where the N number of packet chunks are distributed over the M sectors.

20. The non-transitory computer readable medium of claim 19, wherein the instructions, in response to being executed by the processor, further cause the processor to:
distribute, by the processing circuitry, X number of UEs, where X is a positive integer, per sector.
